(19) United States
(12) Patent Application Publication
(10) Pub. No.: US 2017/0308671 A1
(43) Pub. Date: Oct. 26, 2017

(54) PERSONAL HEALTH AWARENESS SYSTEM AND METHODS

(71) Applicant: Bionous, LLC, Sammamish, WA (US)

(72) Inventors: Ali Bahrami, Sammamish, WA (US); Jila Khorsand, East Greenwich, RI (US)

(21) Appl. No.: 15/491,324

(22) Filed: Apr. 19, 2017

Related U.S. Application Data
(60) Provisional application No. 62/435,001, filed on Dec. 15, 2016.
(60) Provisional application No. 62/325,086, filed on Apr. 20, 2016.

(51) Int. Cl. G06F 19/00

(52) U.S. Cl. CPC G06F 19/3431; G06F 19/345; G06F 19/322; G06F 19/3418

(57) ABSTRACT

Methods and apparatus for providing a health awareness of a medical condition to an individual. An illustrative system includes a healthcare data interface configured to receive clinical data describing healthcare characteristics of the individual, at least one sensor configured to capture over time patient generated data related to the medical condition, and at least one computer processor. The at least one computer processor is programmed to determine a health status of the medical condition based, at least in part, on the received clinical data, the captured patient generated data, and contextual information for the individual and output an indication of the health status to provide the health awareness of the medical condition to the individual.

### CROSS-REFERENCE TO RELATED APPLICATIONS

This application claims the benefit of U.S. Provisional Patent Application Ser. No. 62/325,086, filed Apr. 20, 2016, entitled “Personal Health Awareness System and Methods,” and U.S. Provisional Patent Application Ser. No. 62/435,001, filed Dec. 15, 2016, entitled “Personal Health Awareness System and Methods,” the entire contents of each of which is incorporated by reference herein.

### BACKGROUND

According to the Centers for Disease Control (CDC), chronic diseases and conditions—such as heart disease, stroke, cancer, diabetes, obesity, and arthritis—are among the most common, costly, and preventable of all health problems. For example, as of 2012, about half of all adults-117 million people—had one or more chronic health conditions. One of four adults had two or more chronic health conditions. Seven of the top 10 causes of death in 2010 were related to chronic diseases. Two of these chronic diseases—heart disease and cancer—together accounted for nearly 48% of all deaths. Additionally, obesity is a serious health concern. During 2009-2010, more than one-third of adults, or about 78 million people, were obese (defined as body mass index [BMI]≧30 kg/m2). Nearly one of five youths aged 2-19 years was obese (BMI≧95th percentile). Also, diabetes is a chronic disease with debilitating co-morbidities and life threatening complications if not adequately controlled. The incidence of diabetes has reached epic proportions in recent years. According to CDC, from 1980 to 2014, the number of adults aged 18-79 with newly diagnosed diabetes has more than tripled. Diabetes is the leading cause of kidney failure, lower-limb amputations and blindness among adults. Additionally, about 90% of people with pre-diabetes are unaware of their condition, so most don't get any treatment, since there are no symptoms of pre-diabetes, which can be detected only through blood tests.

### SUMMARY

Personalized healthcare can emerge from high confidence algorithms that can predict actionable interventions that improve long-term health outcomes. However, building models that are able to reduce uncertainty and personalize care requires many factors such as the ability to incorporate new data types and sources, to have reliable, consistent predictive models, timely data, transparency around the prediction, and convenience and contextual recommendations, and a closed feedback loop that allows the model to rapidly learn. To address these challenges, some embodiments are directed to a multidimensional, personalized, extensible context meta-model to represent, correlate, and transform data to information to knowledge to decision for diagnosis and prediction of person health status that can prevent negative events and result in actionable interventions. In particular, some embodiments are directed to transforming a model of “discrete data” diagnosis, disease management and prognosis to “continuous data flow” diagnosis and prognosis by fusing patient generated data and clinical data.

The techniques described herein incorporate a patient's personalized health status model with a hybrid human-machine health analytic to analyze personal baseline biomedical data predicting disease onset and/or detecting disease progression and optimizing health status in individuals who are already in good health. This innovative model has a broad scope of application from those who enjoy a healthy life and would like to maintain their health status to individuals who are at risk of developing chronic diseases sometime during their life and those who already suffer from some form of a chronic illness.

A context-aware and personalized health status model as described herein provides an end-to-end capability to facilitate advanced disease diagnosis, prognosis and prediction of health status. A number of inter-related technical challenges, ranging from personalized biomarkers with adaptable normal value, interoperability among various components, hybrid human-machine health analytics, libraries of prior analysis and associated context and handling context incompleteness/uncertainty, to understanding the role/impact on “organic” cognitive processes and assessing the efficacy of context-aware information services are addressed.

Some embodiments are directed to a Personal Health aWareness (PHware) system implemented as a Continuous Data-to-Information-to-Knowledge-to-Decision (D2IKD) Pipeline of data such as biometrics time series to information and then to knowledge via personalized health status model that can be used in real time by the patient, and patient's healthcare providers to enhance diagnostic accuracy and implement appropriate treatment in a temporally and fiscally superior manner.

Other embodiments are directed to a system for providing a health awareness of a medical condition to an individual. The system comprises a healthcare data interface configured to receive clinical data describing healthcare characteristics of the individual; at least one sensor configured to capture over time patient generated data related to the medical condition; and at least one computer processor programmed to determine a health status of the medical condition based, at least in part, on the received clinical data, the captured patient generated data, and contextual information for the individual; and output an indication of the health status to provide the health awareness of the medical condition to the individual.

Other embodiments are directed to a system for dynamically providing a health awareness to a diabetic patient. The system comprises a healthcare data interface configured to receive clinical data from an electronic health record of the patient; a device configured to non-invasively periodically capture health information from the patient, wherein the health information includes blood pressure, a blood oxygenation level, a pulse rate, temperature, glucose level data, and a photoplethysmograph (PPG); and at least one computer processor programmed to determine a health status of the diabetic patient based, at least in part, on the received clinical data, at least some of the captured health information, and contextual information for the patient; and output an indication of the health status to provide the health awareness to the diabetic patient.

Other embodiments are directed to a system for providing health awareness to a patient. The system comprises a healthcare data interface configured to receive clinical data for the patient; a device configured to non-invasively periodically capture health information from the patient, wherein the health information includes blood pressure, a blood oxygenation level, a pulse rate, temperature, glucose level data, and a photoplethysmograph (PPG); a wearable sensor configured to periodically capture patient generated data, wherein the patient generated data includes one or more of diet information, activity information, step number information, and heart rate information; and at least one computer processor programmed to determine whether the patient is a pre-diabetic patient based, at least in part, on the received clinical data, at least some of the captured health information, the captured patient generated data, and contextual information for the patient; predict, when it is determined that the patient is pre-diabetic, an outcome for the patient, wherein the prediction is based, at least in part, on the received clinical data, at least some of the captured health information, the captured patient generated data, and the contextual information for the patient; and output an indication of the prediction of the outcome to provide the health awareness to the patient.

Other embodiments are directed to a system for providing health awareness of a medical condition to an individual. The system comprises a healthcare data interface configured to receive clinical data describing healthcare characteristics of the individual, patient generated data related to the medical condition, and contextual information for the individual; and at least one computer processor programmed to: determine a health status of the medical condition based, at least in part, on the clinical data, the captured patient generated data, and the contextual information for the individual; and output an indication of the health status to provide the health awareness to the individual.

Other embodiments are directed to a system for establishing for an individual, a personalized baseline measure for at least one biomarker, the system comprises an interface configured to receive longitudinal biomarker data for the at least one biomarker, clinical data describing healthcare characteristics of the individual, patient generated data related to the medical condition, and contextual information for the individual; and at least one processor programmed to determine the personalized baseline measure for the at least one biomarker based, at least in part, on the static health care data, the patient generated data, the contextual information, and the longitudinal biomarker data.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 illustrates dimensions for the multi-dimensional model in accordance with some embodiments;

FIG. 2 illustrates a machine learning and analytical engine workflow that may be used in accordance with some embodiments;

FIG. 3 illustrates a collection of machine learning algorithms that are driven based on context in accordance with some embodiments;

FIG. 4 illustrates a technique for capturing sequencing of contextual events by using cascading machine learning algorithms for diagnosis and presentation of chronic diseases in accordance with some embodiments;

FIG. 5 illustrates some components of a PHware architecture in accordance with some embodiments;

FIGS. 6A and 6B collectively illustrate a presentation layer of the PHware architecture of FIG. 5 in accordance with some embodiments;

FIG. 7 illustrates components of a health awareness system in accordance with some embodiments;

FIG. 8 illustrates a hybrid approach for generating synthetic health data in accordance with some embodiments;

FIG. 9 illustrates a semantic graph that may be used to generate synthetic health data in accordance with some embodiments;

FIG. 10 shows a schematic of a device for noninvasively measuring health information in accordance with some embodiments;

FIG. 11 illustrates a portion of a user interface for displaying health information recorded with the device of FIG. 10 in accordance with some embodiments; and

FIG. 12 illustrates a process for measuring health information using the device of FIG. 10 in accordance with some embodiments.

### DETAILED DESCRIPTION

The current healthcare scheme is ‘reactive’ in the sense that the focus is on treatment rather than prevention. Disease diagnosis in the current system is generally done either through gene sequencing, based on measurement of gene products in bodily fluids or through imaging techniques. In areas where a disease is correlated with the presence or absence of a fixed variable (e.g. mutations in BRCA gene in breast cancer) the current diagnostic regimen is quite effective. However, for chronic conditions, where the disease is often characterized by subtle changes in multiple variables over time, the current diagnostics, which are often based on one data point that is compared to population-based reference ranges, fail to adequately detect the underlying disease. On the other hand, it is important to note that chronic diseases, due to their gradual nature, are inherently preventable and/or manageable. In the current medical system, under best practices, contextual patient information is used in a qualitative manner. For example, habits such as smoking, drinking, exercise etc. might be recorded in a patient's chart and general recommendations provided to the patient accordingly.

To further discuss the latter points, it is useful to consider the example of cardiovascular diseases. Under the current guidelines, annual checkups are recommended for individuals in their fourth or fifth decade of life. These checkups might include physical examination by the physician and a set of blood works to measure biomarkers such as cholesterol and triglycerides for cardiac risk assessment. In cases where the measurements are outside of ‘normal’ ranges follow up tests are ordered and if a treatment needed plan, including recommendations for life style changes, is devised to bring the outlier measurements back in the ‘normal’ range. A few general points can be deduced from the latter scenario:

1) The current system ignores individuals in their ‘healthy’ years (first three decades of life); however according to a recent landmark study many chronic diseases, including those of the cardiac system, start forming in the first three decades of life only to be manifested at a later time.
2) Comparing clinical measurements to reference ranges has limited use in managing chronic conditions. For example, a recent study following more than 200,000 women for over a decade has demonstrated how longitudinal measurement of CA-125 (ovarian cancer biomarker) and establishing ‘personal baselines’ can improve the survival rates when compared to instances where single measurements of CA-125 and comparison to a reference range is used.
3) Contextual information in the current scheme is merely used in a qualitative manner: In the example of cardiac diseases, recommending exercise in general terms is very different than continually monitoring ones activities through wearable sensors and suggesting immediate adjustments in a dynamic form.

With technological advances in the field of diagnostics, generating personalized medical data at a temporally and fiscally reasonable scale is now possible. Precision medicine delivered on an individual basis is therefore primarily a data driven approach meaning that to customize care, health professionals need to aggregate large amounts of specialized information into actionable decision points. However, given the diversity and complexity of medical data, large medical data sets are generally viewed as unfavorable, a major barrier on the path to personalized care.

The inventors have recognized and appreciated that the current healthcare scheme may be improved through the development of a personalized health status model that takes into account multiple personalized sources of information to provide patients with personalized awareness of health conditions. To this end, some embodiments are directed to techniques for developing a multidimensional data-driven and context-aware personalized health status model.

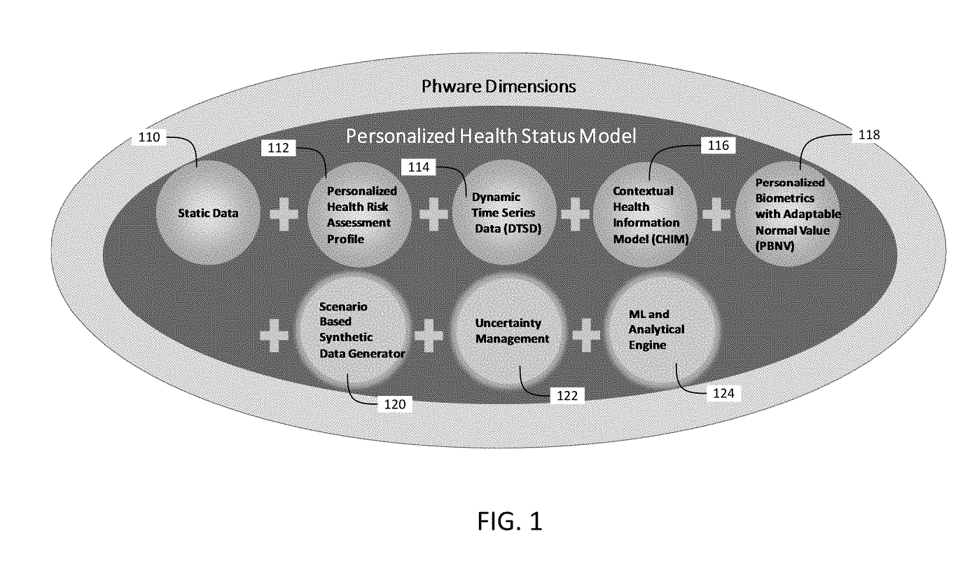

As shown in FIG. 1, in accordance with some embodiments, the dimensions for the multi-dimensional model may include (1) clinical data 110, such as data captured by an Electronic Health Record (EHR); (2) a Personalized Health Risk Assessment Profile (PHRAP) 112 based on one or more genetic, physical, behavioral, psychosocial and diseases profiles; (3) Personalized Biomarkers with Adaptable Normal Value (PBNV) 118 based on longitudinal measurement of biomarkers in bodily fluids for an individual; (4) Dynamic longitudinal biomedical data generated as Time Series Data (DTSD) 114 generated by wearable devices, sensors, and/or other workflows capable of generating longitudinal biomedical data; (5) a Scenario Based Synthetic Data Generator 120 enabling bootstrapping when personalized data doesn't exist; (6) a Contextual Health Information Model (CHIM) 116 to manage relationships among information artifacts that are dynamically influenced by their contexts; (7) Uncertainty Management 122 that supports uncertainty in the form of confidence factor for models and algorithms; and (8) a Machine Learning and Analytical Engine 124 used for one or more of disease diagnosis, prognosis and prediction of health status and predictive analytic. Aspects of each of these dimensions are discussed more detail below.

In some embodiments, a personalized health status model is generated based on some or all of the above dimensions that encapsulate patient's comprehensive health information spanning over past and current information on known patient's disease data, and contextual factors, such as date, time, diet, medication etc. The personalized health status model may then be utilized by a Hybrid Human-Machine Health Analytic for disease diagnosis and/or prediction of patient's health status.

### Illustrative Personalized Model Dimensions

Clinical Data

Clinical data 110 includes a patient's medical history, encounters, lab reports, diagnosis, treatments etc. that usually reside in EMR/EHR systems. This class of data is often also called “static” because it tends not to change as often as patient generated data collected from sensors or other devices, as described in more detail below. Accessing patient health medical data can be challenging since it requires input from multiple information sources, in which there may be a combination of structured, semi-structured, and unstructured data.

The disparate nature of these information sources poses unique challenges and barriers having to do with access, accuracy, semantic understanding, completeness, and correlation of heterogeneous information and therefore successful information integration efforts depend critically on elimination of those barriers. In accordance with some embodiments, a single, unified, coherent, and semantically-informed view of selected data sources is created. The semantics of information content may be explicitly represented by domain ontologies, and it is against these ontologies that queries may be issued to retrieve an integrated set of clinical data in a coherent manner. In one aspect, a system metadata repository is created containing logical design information for any targeted systems and mappings between the domain ontology and the logical models. The domain ontology not only serves as the conceptual representation of the information domain, but may also be used to resolve the heterogeneity of the concepts in related health data systems. Other metadata may serve to encapsulate each member data system by providing a logical representation of the system's content—these logical elements may be mapped to concepts in the ontological model and together “mediate” the system information requests for clinical data

Personalized Health Risk Assessment Profile (PHRAP)

In some embodiments, the personalized health status model is configured to adapt based on individual characteristics. A Personalized Health Risk Assessment Profile 112 describes a patient's characteristics in regards to their health information. For example, the health information may include physical and medical history including genetic information, family history, dietary restrictions, food allergies and intolerances, smoking history, drinking history, drug abuse, exposure to toxins as well as the patient's behavioral/psychosocial background. Some of the characteristics are relatively static, such as the genetic information or user's education, preferences, and health classification; but many others are highly dynamic (e.g. current locations, average Glucose level for current day, etc.) that change significantly depending on the situation.

Companies that screen for underlying genetic factors (e.g., 23andMe, Navigenics, deCODE) provide a lineage analysis and as well as genomic profiling for some well-known diseases linked to specific SNP(s) within the human genome. While in most of these cases, presence or absence of a genotype does not necessarily dictate phenotypic manifestations, such information may be included in the overall patient assessment: a feature that is not currently well-integrated into most clinical practices.

In accordance with some embodiments, a patient's health profile is used to adjust an information aggregation request, such that the aggregated information content reflects the patient's specific health condition. Furthermore, the aggregated data collection may be used as input to a machine learning process for generating the personalized health status model.

### Dynamic Longitudinal Biomedical Data Generated as Time Series Data (DTSD)

The healthcare data generation landscape is rapidly changing, including patient-generated data (such as continuous monitoring data from patches and wearable devices) and patient-reported data (such as meal logging, mood logging, and social media), increasingly being used for analytics. The biometric time series based data generated by personal sensors or wearable computers may be used in accordance with some embodiments to generate a personalized health status model.

A future disease or health behavior may be output by the biometric time series based model using personal biomedical baselines for a given biomarker or a panel of biomarkers and existing contextual factors for the individual. The biometric time series can be used in real time by patient, and patient's healthcare providers to improve accuracy of diagnoses, treatments and improve the overall quality of patient health at lower cost.

Patient generated longitudinal biomedical data or time series data (DTSD) 114 is being produced at an increasing rate. Patient generated time series data are called “dynamic” because they change more often than clinical data discussed above, and may be able to better represent a current patient health status model. Patient generated data are currently analyzed without a comprehensive model. Notably the current platforms are not able to address issues such as efficient and effective aggregation of various data sources, storage of large data sets, and they are not able to perform multidimensional analysis of the data to improve health outcomes. The techniques described herein make patient generated time series data first class data for creating a personalized health status model.

In some embodiments, a time series may be defined as an ordered sequence of values of a variable at spaced time intervals. Time series analysis occurs frequently when analyzing industrial data.

Some embodiments employ one or more of these approaches and techniques to time series health data and time series analytics such as feature extraction and subsequent clustering and machine learning.

Personalized Biomarkers with Adaptable Normal Value (PBNV)

The concept of personalized care has long been discussed in the medical field. The underlying argument for personalizing medicine is the concept of biochemical individuality, which points to uniqueness of each and every individual at molecular level (even genetically identical twins can have diverse molecular profiles based on their environment etc.). Despite its advantages, the use of personal ‘baselines’ for biomarkers has not been widely implemented in clinical settings due, in part, to technical challenges and cost implications. In some embodiments, personal baselines 118 for one or more biomarkers (e.g., through longitudinal measurement of biomolecules in bodily fluids) based on single or multi-marker panels are used to help differentiate between ‘normal’ and ‘aberrant’ biological variations for each individual.

Some embodiments process such personalized biomarker measurements in the following ways:
Establishing ‘normal’ personal baselines for each biomarker (normal biological variation).
Detecting ‘aberrant’ fluctuations in biomarker levels based on the personalized baselines established.
In cases where panels of biomarkers are measured (for diagnostic or prognostic purposes), patterns and relationships between these biomarkers are identified and presented in a simple manner.
Using machine learning algorithms to study personal baselines and patterns to predict a future outcome based on current data points.

### Scenario Based Synthetic Data Generator

Hybrid Approach for Generating Scenario-Based Synthetic Data Generation

The inventors have recognized and appreciated that initially the data used to generate a personalized health information model for a patient may be sparse and the model may be refined as more personalized data becomes available. To account for initially sparse data, some embodiments provide for bootstrapping the process when data doesn't exist by generating synthetic data that approximates the individual's personalized data. In some instances large amounts of data may be generated by humans, machines and devices for use in a personalized model. For example, for patient-generated data, massive data streams can range from daily aggregate values of steps computed by consumer wearable devices to FDA regulated medical devices. Blood glucose data may be received multiple times a day or a patient's weight may be measured every few months. Though different in many ways, these examples share common features that shape a personalized model generated in accordance with the techniques described herein.

In some domains the opposite is also true: The data may not exist or be collected based on certain specifications. In the health care domain this can be a major issue, even though HIPAA requires that patients have access to all of their medical data in many cases health care providers will not provide the data for the same reason. To address the challenge of accessing the patient's medical data prior to generating a personalized health status model for the patient, and since the model is data driven, and thus a fair amount of personalized biometric data based on associated biomarkers is typically required, some embodiments employ a synthetic data generator to provide a bootstrapping process. While the synthetically-generate data may be the starting point for the model and may not reflect the patient's true personalized model initially, over time as the user/patient uses the personal health awareness system, the initial synthetic data will be replaced with the patient-generated data.

A real scenario based synthetic data generator 120 for use with some embodiments helps provide a mathematical relationship between a selected group of biomarkers using a large number of fictional subjects covering the spectrum of healthy—to pre-disease to diseased conditions. This mathematical relationship may then be applied to real subjects to assess risk of development of the disease or predict the risk of impending serious complications that can be averted in a timely fashion.

A scenario based synthetic data generator may also be used in some embodiments to create data with a known ground truth, where a scenario can be created and elements of the scenario mapped to the data. Such a synthetic data generator may generate multivariate data using statistical, rule-based, and semantic approaches, and provide a significant speed-up in iterations of data set creation.

Most conventional techniques for generating synthetic data were developed for specific applications, such as testing information discovery and analysis systems or software testing. Some embodiments are directed to a synthetic data generator that allows creation of multidimensional datasets capable of effectively capturing longitudinal patient data, and by doing so, to create a set of models that can be used to generate synthetic longitudinal data based on available data. Some embodiments generate synthetic data that captures a variety of types of data present in health, healthcare, and medical domains. Some synthetically-generated datasets for use in data driven algorithms, examples of which are described herein, have a large number of dimensions. The values in one or more of the dimensions may be randomly generated and multidimensional structures may then be defined in the remaining dimensions. Some examples of such structures include, but are not limited to, correlations and clusters between selected dimensions. A dataset may contain complex structures that are difficult to synthetically generate using existing algorithms, e.g., non-orthogonal structures or non-linear correlation between dimensions. Some embodiments are capable of generating realistic complex medical data to enable bootstrapping a data-driven system for diagnoses and preventions of diseases, examples of which are described herein.

Some embodiments are directed to a hybrid approach by using machine learning to find patterns from real data when sample real data exist and automatically generating a model that can be used to generate a large amount of data for a data-driven system for providing patient awareness of health conditions. When actual patient data doesn't exist, some embodiments defining the model and the structures in the multidimensional space by using a semantic graph and probability density functions for generating synthetic data. The generated data may be used as starting point to initially train machine learning techniques.

### Contextual Health Information Model (CHIM)

In some embodiments, contextual health information for a patient is modeled using a contextual health information model (CHIM) 118 by sequencing and capturing relationships among information artifacts that are dynamically influenced by their context.

Some embodiments are directed to techniques for gathering, linking, and transforming information artifacts into relevant knowledge, not only based on the static and dynamic time series data, but also additional contextual factors. Having context around an individual's historical data important in healthcare where ‘healthy’ or ‘normal’ is best defined on an individual basis. Textbook guidelines often provide ranges that are integrated into EHR/EMR systems without any context that customizes the guidelines for each patient. For instance, data collected from the Cincinnati Children's Hospital Medical Center and Children's Hospital of Philadelphia showed that 14 to 38% of heart rate observations and 15% to 30% of respiratory rate observations would have resulted in false alerts based on textbook definitions. Accordingly, some personalized health status models developed using the techniques described herein adapt based on each individual by taking into consideration contextual information for that individual. Specifically, the model enables information artifacts to be appropriately associated, in “real-time,” with their contextual backgrounds including, but not limited to, date, time, diet, medication, personalized biomarkers etc. These contextual backgrounds can further be used in real time by the patient, and patient's healthcare providers to improve accuracy of diagnoses, treatments and improve the overall quality of patient health at lower cost.

Contextual information may include any information that can be used in the realization of meaning of an entity for a given information consumer, or to characterize the situation of an entity; where an entity can be a person, place, or physical or computational object. Certain types of contexts that are, in practice, more basic than others (e.g. location, identity, and time), can be categorized as primary contexts. Other types of contexts (e.g. health status) called secondary or derivative contexts may be derived from primary contexts.

The relationships among information artifacts are dynamically influenced by their contexts. For example, by specifying the diet, smoking habits, psychological well-being and state of individual's static health, multiple information artifacts can be retrieved and aggregated in real time, including personalized biometrics, longitudinal measurements from single or a panel of biomolecules, etc. Such aggregation can then reveals further opportunities, help to mitigate risk and provide early warnings.

Some embodiments include a context meta-model mechanism that works with existing contextual ontologies (e.g. time, location, state of health, etc.) and provides mapping among one and another. Existing capabilities of mappings between ontologies and lower-level data structures may be leveraged, and used to generate a generic context model management/mapping formalism to import existing models, enrich the semantic understanding of contextual content, capture contextual alignments, and perform progressive amendment in response to the dynamically changing environment.

The meaning of various contextual data is usually hidden or highly embedded in various data systems. This is one of the major barriers for a truly shared understanding among information consumers. Some embodiments include ontologies and algorithms developed to enrich the semantics of contextual content, by using tagging data models and data instances with context ontologies. Tagging and mapping techniques for use with some embodiments provide varying degrees of domain-customized generality (e.g. conceptual grouping) and specialization (e.g. approximation via uncertainty) to deal with the dynamically changing information space.

The “noisy” factor of original data entry, such as errors, duplicates, and missing values (e.g. sensor readings) may invalidate some existing contextual mappings and further cause failure of reasoning engine to derive secondary contexts. New information sources may also be added, and the new data may not fit well with existing mappings. In accordance with some embodiments, features such as conditional contextual alignments, uncertainties of contextual similarity, and entity resolution specifics into the contextual mapping mechanism may be used, as well as developing alignment integrity and consistency checking axioms for real-time alignment, validation and progressive amendment in response to changes and exceptions. Semantic rules may be used to compose/decompose existing alignments within a hierarchical structure, as well as append/relax alignment conditions and/or confidence levels for approximations, to greatly increase the adaptability and reliability of context data management and dissemination in dynamic environments.

The information producer/consumers, e.g., the patient and provider, each generate or capture data acting as information producers and consumers, and their roles vary greatly under various circumstances and contexts. Each agent takes a role in handling the context where importance is indicated by the priority. An extensible context model for use with some embodiments applies “user-centric” confidence values (e.g., depicting the relevancy to a particular biomarker) to low-level contextual facts, which can be propagated to high-level contextual information according to the specific roles that different information producers/consumers are playing in order to improve the effectiveness and efficiency of contextual reasoning capability.

### Uncertainty Management

Personalized healthcare can emerge from high confidence algorithms that can predict actionable interventions that improve long-term health outcomes.

Real data is noisy, dirty with many missing values, resulting in uncertainty about the presence of data objects, or confidence values associated with alternative values. While these features capture many of the uncertainties that arise in data integration, an approach for modeling uncertainty in accordance with some embodiments may require additional uncertainty modeling constructs, for example:
Unknown and speculative values: Applications typically record unknown values in databases using a built-in NULL feature. NULL values may be used in our databases in the same fashion. However, the invention provides more powerful management and processing of uncertain data than a conventional database, additional efficiency, functionality, and especially ease-of-use can be achieved by integrating the concept of unknown values into the uncertainty model. Furthermore, analysts frequently speculate on values without full confidence of correctness. Designated speculative values, which are not supported by conventional Database Management Systems (DBMSs), can be added to the personalized model seamlessly.

Applications and users may continuously add data as input to the personal health awareness system, but frequently the current set of data objects nevertheless may be incomplete. Often the degree of completeness of a stored data set is known, but that information resides outside of the database, sometimes outside of the application and only in human knowledge. An uncertainty management module 122 for use with some embodiments can model degree of completeness or confidence and stored with the data, it can be retrieved and updated systematically, and more importantly this information can be used during machine learning and uncertainty may be assigned to a generated model to provide more meaningful results for a hybrid-human machine health analytic.

Context-Aware Machine Learning and Analytical Engine with Uncertainty Management

In some embodiments, machine learning with uncertainty management may be used to enable a data-driven personalized health status model. Using machine learning techniques to analyze personal biomedical baselines along other dimensions to predict future health status allows for development of biometric time series models for predicting disease onset and/or progression and for optimizing a health status in individuals who are otherwise healthy. Such machine learning techniques are expected to provide increased levels of accuracy while considering a holistic approach by utilizing clinical data, patient generated data, individual profile information, and contextual information in the prediction process which have been infrequently introduced by conventional solutions.

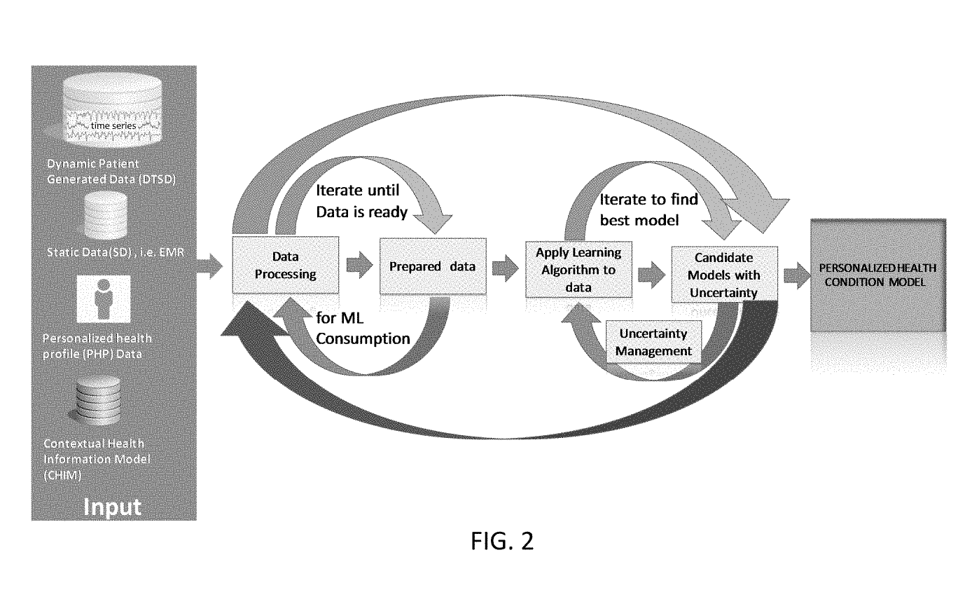

Machine learning offers an approach for developing sophisticated, automatic, and objective algorithms for analysis of high-dimensional and multimodal biomedical data. Machine learning that uses one or more of dynamic patient generated time series data (DTSD), clinical data from an EHR, personalized health risk assessment profile (PHRAP) data, and data captured based on Contextual Health Information Model (CHIM) to learn the personalized Health Status model can be used in real time for improving detection, diagnosis, and therapeutic monitoring of disease. See, for example, FIG. 2, which illustrates a machine learning and analytical engine workflow.

Since not all attributes in the datasets may be potentially significant in terms of learning and generating a personalized health status model, the important features to be used by the underlying machine learning algorithms may be extracted from various datasets. A data parser may allow users to dynamically define which subset of important features should be extracted. The detailed feature subset may be different among different learning algorithms and for different learning purposes. Such a dynamic feature selection provides high flexibility and reusability of the data parser. The data parser also takes two other types of knowledge namely prior knowledge and rules about how to clean and normalize the value of each selected feature so that it can be consumed by the underlying machine learning algorithms. After extracting selected features from the input data, another step is to correctly align all the sets of extracted features into a unified feature set for training. Uncertainty of the generated model may be assigned, for example, based on the uncertainty management dimension.

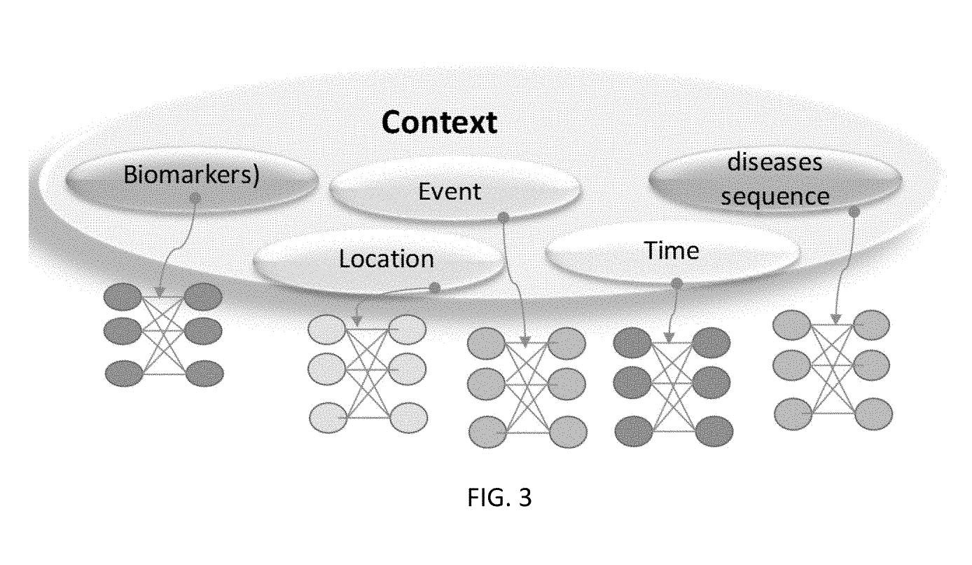

FIG. 3 shows a collection of machine learning algorithms that are driven based on context in accordance with some embodiments. Such a collection of machine learning algorithms may be used to improve the accuracy of prediction and to be able to predict outcomes with a longer time window compared to single machine learning algorithms.

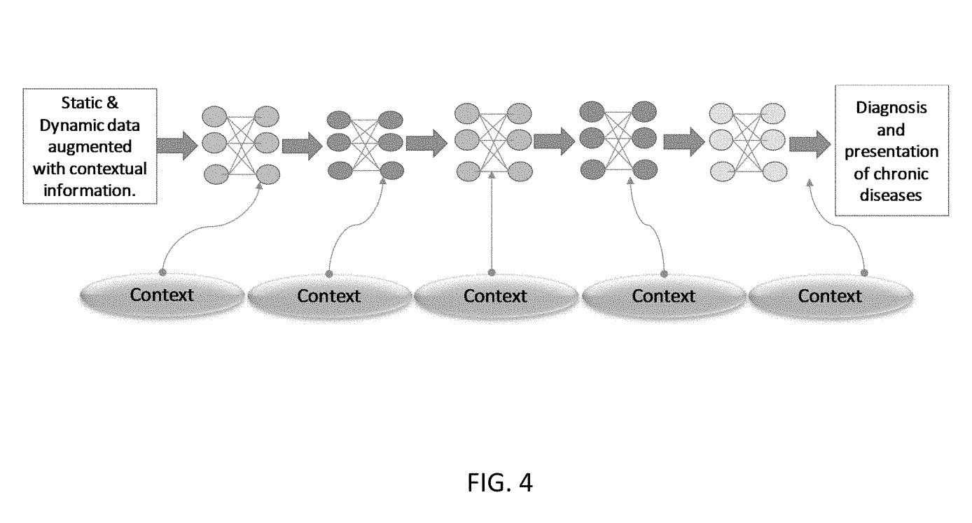

FIG. 4 schematically illustrates a technique for capturing sequencing of contextual events by using cascading machine learning algorithms for diagnosis and presentation of chronic diseases in accordance with some embodiments.

### Personalized Model Analysis

Hybrid Human-Machine Health Analytics

Once the personalized health status model is generated, the model may be used for predictive analytics in some embodiments. Rather than changing doctor-patient relationships, the purpose of the personalized health awareness model is to better measure, aggregate, and make sense of previously hard-to-obtain or non-existent biometric data, and understand the relationships between external factors and human biology to enable personalized healthcare and to enable the best decisions to be made, allowing for care to be customized on an individual basis.

Most of the traditional medicine and health care system operates under “predictive analytics” today, driven by physicians' minds versus computer-implemented analytical tools. Applying predictive analytics to medicine widens the training data set beyond an individual's experiences so that individual patients can be better treated.

Personalized care can emerge from high confidence algorithms that can predict actionable interventions that improve long-term health outcomes. However, building models that are able to reduce uncertainty and personalize care may require many factors as discussed earlier. One such factor is a closed feedback loop that allows the model to learn rapidly. In health care, the feedback loop which is often measured in terms of impact on biometric or cost outcomes, can take many years. To address this issue and to keep healthcare providers in the loop while retaining the ability to have instantaneous feedback, some embodiments employ hybrid human-machine healthcare analytics.

Human health providers are often better than algorithms at diagnosis. However, compared to algorithmic techniques health providers are much slower, may not be available and are more expensive. A hybrid human-machine approach has the potential to combine the efficiency of machine-based approaches with the answer quality that can be obtained from a health specialist.

Hybrid human-machine health analytics techniques that may be used in accordance with some embodiments include the following steps:
Generating the personalized health model as described above to perform analytics. Associated with each analysis may be a confidence factor, and if the confidence value of analysis is below a certain threshold, the system may be transmitted to a crowd of health providers for answers similar to crowdsourcing. So in other words the system may ask for human help only when automatic algorithms are unsure.
Providing the user with a result if the confidence factor is high (above the threshold) then the system provides the user with the result.
Improving the model and learning using the interaction as a feedback loop.

### PHware-Personal Health Awareness System

Continuous Data-to-Information-to-Knowledge-to-Decision (D2IKD) Pipeline

In some embodiments, raw clinical and patient generated data is transferred into useful knowledge for decision making. Specifically, the PHware D2IDK in accordance with some embodiments keeps both the patient and doctor in the loop and the pipeline is preparing and creating multiple data points to represent states of such transition and anticipated events, ultimately creating a more efficient way of processing data in a timely fashion where data has clear value and relevance to decisions. A data point represents a particular state of data, which is prepared specifically for consumption by various algorithms. The data point may be either pre-materialized persistently or created on the fly. The creation of a data point may involve multiple steps. Each step may employ multiple advanced algorithms and services for the purposes of data cleansing, context data acquisition, semantics enrichment, value extraction, uncertainty reduction, etc.

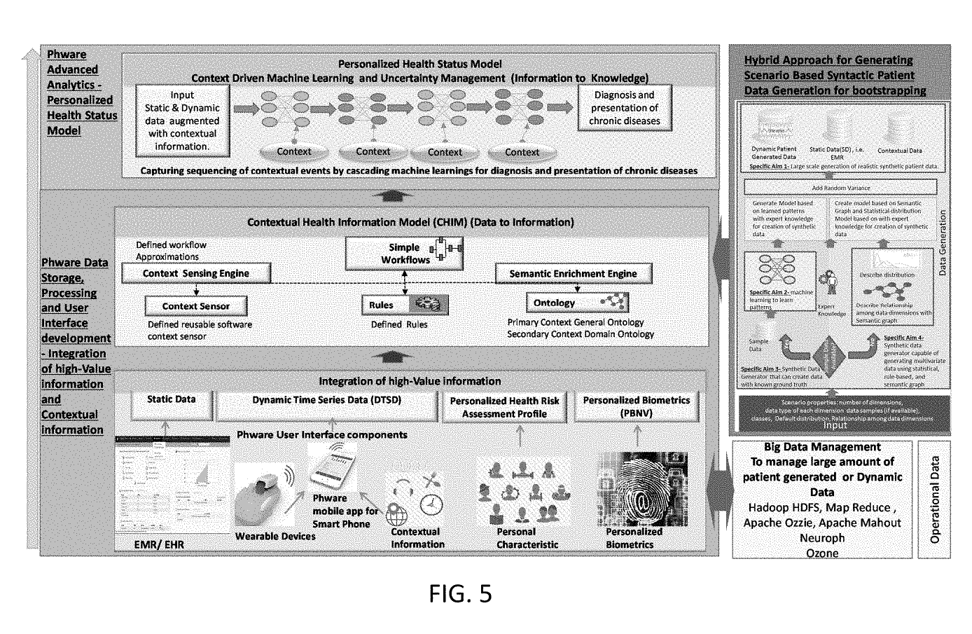

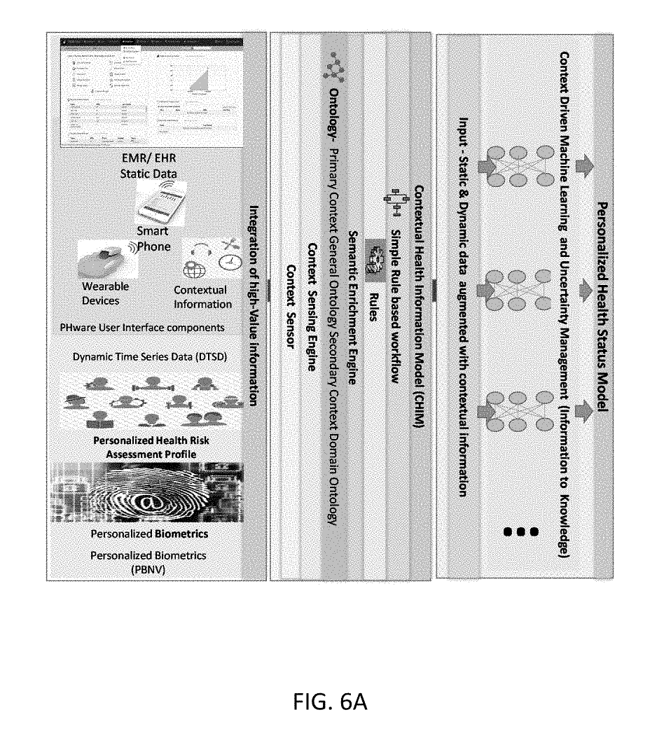

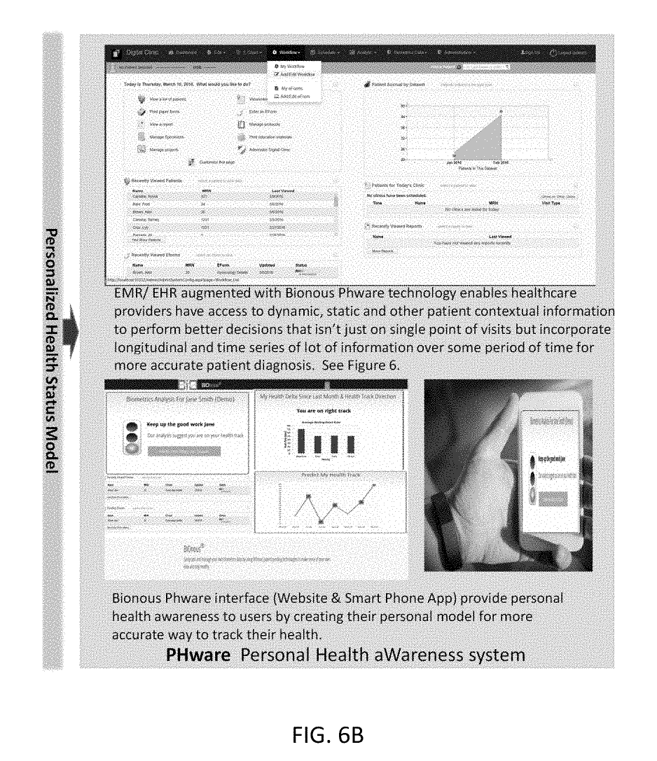

Decision making is often not driven by meaningful data but by the lack of it. The process of manually manipulating data and interpreting it is time-consuming, laborious, and error-prone. The decision support pipeline used in accordance with some embodiments enables pluggable algorithms, services, and methods to dynamically link, group, aggregate, and merge contextually relevant information, and reusability of previous experiences so that individual patients can be better treated through D2IKD pipeline. FIG. 5 depicts some components of the PHware architecture, and FIGS. 6A and 6B collectively illustrate a presentation layer of the PHware architecture in accordance with some embodiments.

EMR/EHR data augmented with the techniques described herein enables healthcare providers have access to dynamic, static and other patient contextual information to perform better decisions that incorporates longitudinal and time series analysis of different sources of information rather than focusing only on data collected at single visits to the healthcare provider, which may result in a more accurate patient diagnosis.

Some embodiments include a PHware interface (e.g., a website and/or mobile device app) that provides personal health awareness to users by creating their personal model enabling the user to more accurately way to track their health, as shown in FIG. 6B.

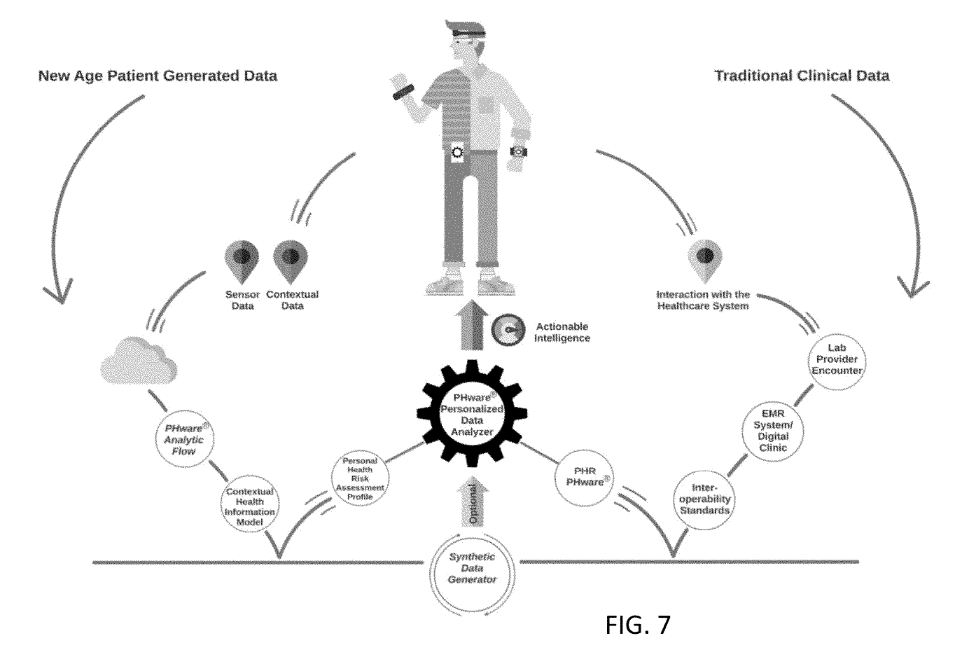

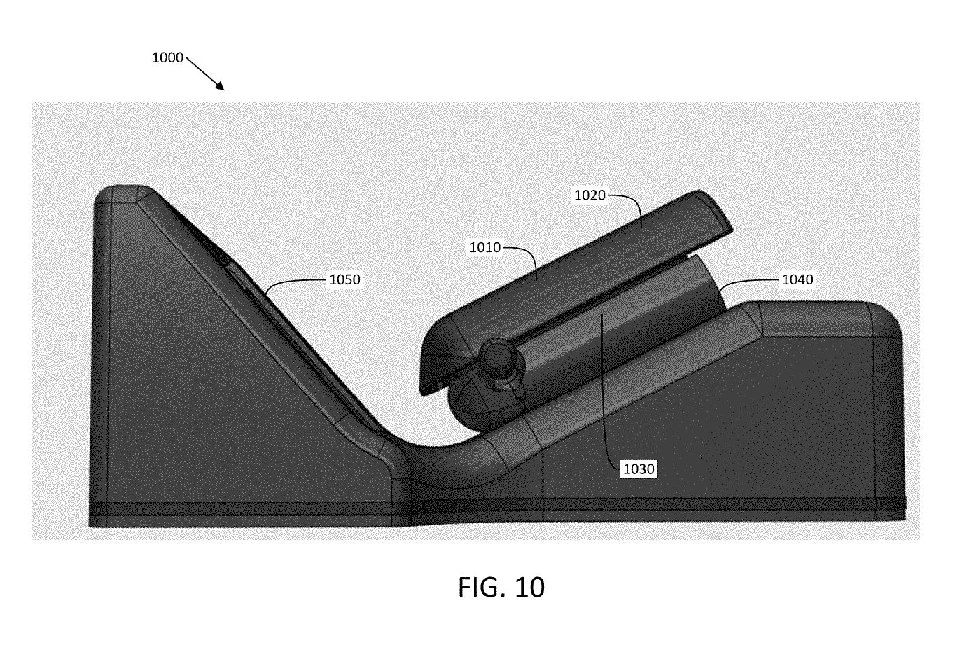

FIG. 7 illustrates components of a health awareness system in accordance with some embodiments. The health awareness system in accordance with some embodiments transforms a model of “discrete data” to a model “continuous data flow” by combining clinical data with patient generated data to provide actionable intelligence. As shown, patient generated data may include sensor data and/or contextual data for a patient. In some embodiments, at least some of the sensor data is captured by one or more wearable sensors. Alternatively or additionally, at least some of the sensor data may be captured by a non-wearable device configured to non-invasively measure health information (e.g., vital signs) from a patient. A non-limiting example of such a non-wearable device is described below in connection with FIGS. 10-12. In some embodiments, the contextual data is determined, at least in part, from the sensor data. As shown, the patient generated data may be analyzed in accordance with a contextual health information model to generate a personal health risk assessment profile for the patient.

The health awareness system may interact with one or more healthcare systems to receive clinical data including, but not limited to, lab provider encounter data and information from an electronic medical record of the patient. As shown the health awareness system includes a data analyzer that fuses information based, at least in part on the patient generated data with at least some of the received clinical data to provide actionable intelligence to the patient. Optionally, as discussed in more detail below, the health awareness system include a synthetic data generator that provides synthetic data to the data analyzer.

### Illustrative Example of a Synthetic Data Generator

Comprehensive patient data is an important factor in managing a patient's overall health and equips providers with an essential tool in providing a better quality of care through preventative measures especially when addressing chronic medical conditions.

Data-Driven medicine for early diagnosis and prevention of chronic diseases typically requires large, disease-specific medical data, which either does not exist for most conditions or is kept in exclusive, hard-to-access repositories. To address this challenge, some embodiments are directed to a hybrid approach by using machine learning to find patterns in real population data and to automatically generate a multidimensional model form available population data for generation of synthetic models that can be applied at an individual level. However, if sample data doesn't exist for other dimension of data, the techniques described herein may enable users to define the model and the data structures in the multidimensional space by a semantic graph and probability density functions for generating synthetic patient data.

A synthetic data generator is the starting point for situations where data may not exist or may not be readily accessible. Although this approach may not reflect the patient's true personalized data, the synthetic generated data can be used as starting point for initial design of machine learning algorithms and may enable data driven medicine. The synthetic data generation provides transitional data that over time will be replaced with patient generated data as it becomes available.

Some aspects of the synthetic data generator are directed to large scale generation of realistic synthetic patient data that go beyond what is often seen in synthetic data (i.e., demographics or claims), but be able to additionally generate clinical, consumer-generated and contextual data.

Other aspects are directed to developing a synthetic data generator that can create data with known ground truth e.g., data available from large scale public health studies.

Other aspects are directed to using machine learning to learn models from real data, combining these models with expert knowledge, and together applying the combination to generate new synthetic data.

Other aspects are directed to a synthetic data generator capable of generating multidimensional data using statistical, rule-based, and semantic graph approaches, that enables synthetic generation of multidimensional datasets.

Other aspects are directed to enabling a context-aware personal health awareness system (PHware) for early diagnosis, and prevention of chronic diseases.

A conventional solution for generating synthetic data is to use well known statistical tools or develop small problem-oriented applications, which can be a time-consuming task. Some embodiments adopt a framework for synthetic data generation that allows creation of multidimensional datasets using machine learning techniques capable of effectively capturing longitudinal patient data, and by doing so to create a set of models that can be used to generate synthetic longitudinal data. By doing so, a variety of types of data present in health, healthcare, and medical domains may be captured in the synthetic data that is generated.

A synthetically generated dataset for use in data driven algorithms such as the personal health awareness system described herein may have a large number of dimensions. The values in some dimensions may be randomly generated and multidimensional structures may then be defined for the remaining dimensions. Some examples of such structures are correlations or clusters between selected dimensions. A useful dataset may contain complex structures that are difficult to synthetically generate using existing algorithms, e.g., non-orthogonal structures or non-linear correlation between dimensions. Some embodiments are able to comb through complex medical data to enable true data driven decision making for diagnoses and preventions of diseases.

To be adequate substitutes for real data, the quality of synthetic data sets should be reasonable. Pitfalls with unrepresentative data include improper training of machine learning or data mining tools and masking of true benefits and virtues associated with data driven techniques to medicine. To varying degrees, existing synthetic generator systems come with a pre-defined set of attributes whose values are available from built-in lists. For example, lists could include names, addresses, occupations, etc. Existing tools are incapable of preserving the complexity between-attribute relationships, but instead simply generate attributes as though they are independent.

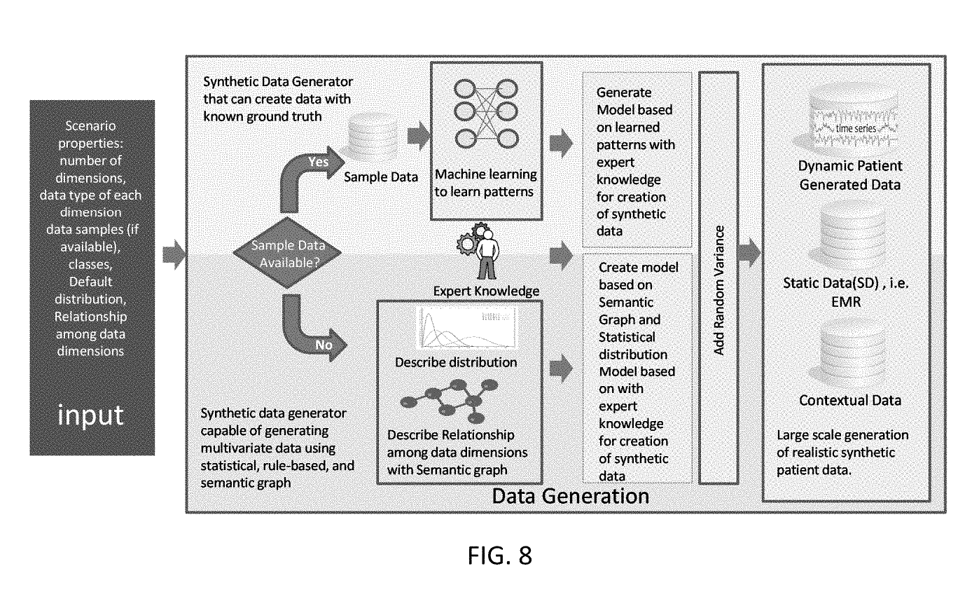

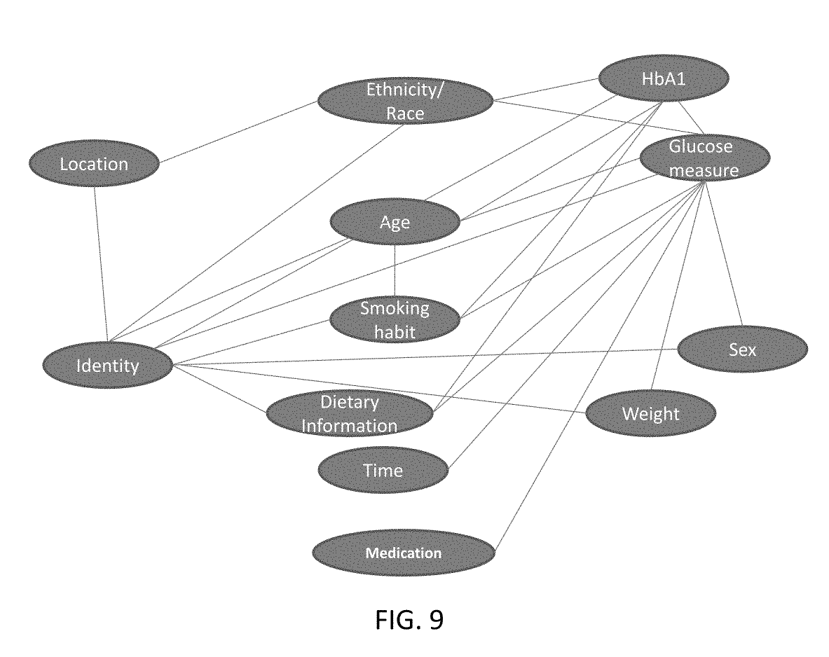

Addressing this shortcoming, some embodiments employ a hybrid approach for generating synthetic health data. An illustration of a hybrid approach that may be used in accordance with some embodiments is illustrated in FIG. 8. As shown, if a ground truth exists (e.g. sample data is available) the synthetic data generator uses machine learning to learn models from the available data, combines these models with expert knowledge, and applies to the combination to generate new synthetic data. If data is not available, a multivariate model may be created based on semantic graphs to represent relationships among data attributes and statistical distributions with expert knowledge to generate synthetic data. An example of a semantic graph that may be used in a synthetic data generator in accordance with some embodiments is shown in FIG. 9.

As an example of using a semantic graph, in the case of chronic conditions such as diabetes, the synthetic data generator may create subjects with normal glycemic, pre-diabetic and diabetic models based on defined clinical criteria (see Table 1).

TABLE 1
Criteria for the diagnosis of diabetes and pre-
diabetes in nonpregnant adults that can be used
as rules for generating diabetes synthetic data.

| | Fasting Plasma | Casual Plasma | Oral Glucose |
|---|---|---|---|
| | Glucose (FPG)* | Glucose | Tolerance |
| | (preferred) | (CPG)** | Test (OGTT)*** |
| Diabetes | FPG ≧126 mg/dl | Casual Plasma | Two-hour Plasma |
| Mellitus | | Glucose | Glucose |
| | | ≧200 mg/dl | (2-h PG) ≧200 mg/dl |
| | | plus symptoms | |
| | | of diabetes | |
| Pre-diabetes | Impaired Fasting | | Impaired Glucose |
| | Glucose (IFG) | | Tolerance (IGT) |
| | FPG ≧100 and | | 2-h PG ≧140 and |
| | <126 mg/dl | | <200 mg/dl |
| Normal | FPG <100 mg/dl | | 2-h PG <140 mg/dl |

These conditions are broad categories that can then be refined based on such factors as anthropometric characteristics (e.g. body mass index, waist/hip ratio etc.), ethnicity, age, life style characteristics (e.g. diet and exercise) and biochemical characteristics (e.g. lipid profile, CRP levels, HbA1c etc.).

Some embodiments for synthetic data generation allow creation of multivariate datasets using machine learning methods capable of effectively capturing longitudinal patient data, and by doing so to create a set of models that can be used to generate synthetic longitudinal data. By doing so, a variety of types of data present in health, healthcare, and medical domains may be captured along with its associated contextual data. In some embodiments, a synthetic patient data generator generates the following types of data:

Patient Clinical Data

As discussed above, clinical data includes data that doesn't change as often as patient generated data and can include, but is not limited to, a patient's medical history, encounters, diagnosis, treatments etc. that usually reside in EMR/EHR systems. Generating static patient medical data can be challenging since data is combination of structured, semi-structured, and unstructured data. Examples of patient clinical data include:
Demographics—includes information that may or may not change such as: name, MRN, DOB, SSN, race, ethnicity, and place of birth.
Family History—used as an additional factor as a part of the patient's medical history which may or may not typically coded.
Immunizations—availability of vaccinations including immunization guidelines on or during the patient's lifespan considering that vaccinations and immunizations change over time.
Diagnoses—play an essential role in providing the appropriate care and preventing associated comorbidities. Diagnoses may or may not be coded which can also be a part of the provider's progress notes.
Other—procedures, treatments, prescriptions or drugs, physician orders, radiological tests and images, dental information, billing, survey and other related patient assessments.

Patient Generated Data

The healthcare data generation landscape is rapidly changing, including patient-generated data (such as continuous monitoring data from patches and wearable devices) and patient-reported data (such as meal logging, mood logging, and social media), increasingly being used for analytics. The patient generated data includes biometric time series based data generated by personal sensors or wearable computers. The synthetic data generator in accordance with some embodiments generates patient-generated data including, but not limited to, vitals, lab results, sensors, social media and genomic data. For example, the synthetic data generator may generate the following data that may not be independent of each other:
HbA1c measurements including time of sample collection,
Duration of disease.
Medication and dosage,
Dietary information,
Smoking habit,
Glucose measurements including time of sampling.

Contextual Data

The relationships among information artifacts in healthcare are dynamically influenced by their contexts. For example, by specifying the diet, smoking habits, psychological well-being and state of individual's static health, multiple information artifacts can be retrieved and aggregated, including personalized biometrics, longitudinal measurements from single or a panel of biomolecules, etc. A synthetic data generator in accordance with some embodiments may use existing contextual ontologies (e.g. time, location, state of health, etc.) and leverage existing capabilities of mappings between ontologies and lower-level data structure to create a generic context model that encodes this rich relationship for generating contextual data in addition to static and dynamic patient data.

As discussed above, in some embodiments, a hybrid approach uses machine learning to find patterns in real data and to automatically generate the model that can be used to generate data or define the model and the structures in the multidimensional space by the semantic graph and probability density functions for generating synthetic data.

First, the user may provide basic information about the desired dataset, e.g. number of dimensions and samples. Second, the user may define a set of structures in the multidimensional space that are represented by probability density functions and a semantic graph. Finally, all points may be generated by machine learning or manually constructed by allowing users to create classified and unclassified high dimensional datasets and to insert complex structures present in real data to correlations between the attributes and clusters with different forms and dimensions as shown in FIG. 8.

For example, in the context of individuals with type 2 diabetes, a person's age, sex, ethnicity, diet, smoking habit, medication time may impact the person's glucose as depicted in semantic graph shown in FIG. 9. Subjects with higher weight, dietary and smoking habit generally have a higher glucose level in their blood. A synthetic data generator in accordance with some embodiments generates these attributes by constructing an n-dimensional (e.g., 12-dimensional) joint distribution for these attributes from knowledge about lower dimensional associations. The multi-dimensional joint distribution may then built by imposing that its corresponding two-way marginal distributions match these observed distributions. The multi-dimensional distribution may be fit to the data using an iterative proportional fitting algorithm (IPF). This approach has two desirable features. First, it reflects exactly the information that is available concerning associations between these attributes—nothing more and nothing less. Second, the number of inputted lower dimensional marginal is a lever that is proportional to the quality of the synthetic data that gets generated. As additional lower dimensional information is input, the synthetic data becomes more realistic. Furthermore, the IPF algorithm can be easily adapted to include additional information about attribute associations as it becomes available.

Rule-based algorithms may be used for attributes that have specified types of random patterns. One example is a study from China in which 26001 Asian-Indian, non-diabetic adult subjects were followed for the development of pre-diabetes and diabetes for 20 years. Knowing the criteria for diagnosis of pre-diabetes, diabetes, and also the study's finding, synthetic data based on real findings can be generated. Criteria for the diagnosis of diabetes and pre-diabetes in nonpregnant adults are shown in Table 1 above. In one example, these criteria can be used as rules for generating synthetic data in context of type 2 diabetes in accordance with some embodiments.

### Illustrative Device

Some embodiments are directed to a device configured to noninvasively measure a plurality of vital signs. FIG. 10 illustrates an example of such a device 1000 that includes a plurality of sensors configured to measure a plurality of vital signs. For example, the sensors may include a plurality of light (e.g., LED) sensors 1010, temperature sensors 1020, and a plurality of photosensors 1030. Device 1000 also includes a finger probe 1040 within which a user of the device inserts their finger to enable measurement of the vital signs.

In some embodiments, LED sensors 1010 includes four different types of LED light sources configured to emit light at different wavelengths and photosensors 1030 include photosensors configured to detect the different wavelengths of light emitted by the four different types of LED light sources after passing through a user's finger placed in the finger probe 1040. For example, LED sensors 1010 may include one or more green LEDs, one or more red LEDs, one or more infrared (IR) LEDs, and one or more near-infrared (NIR) LEDs. Light emitted from the different types of LED sensors 1010 is absorbed at different rates through the blood in a user's finger, and the light reflected by the skin of the user's finger may be detected by photosensors 930 to detect one or more vital signs.

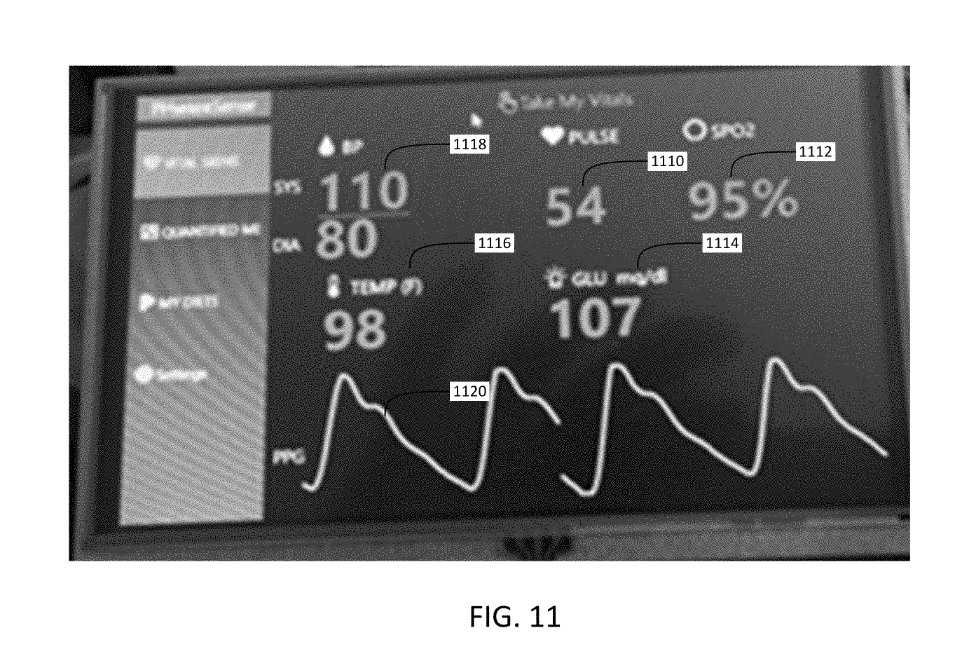

Device 1000 also includes display 1050 configured to display one or more noninvasive measurements made with the device in accordance with some embodiments. FIG. 11 illustrates a portion of a user interface that may be displayed on display 1050 in accordance with some embodiments. Data measured using the sensors (e.g., sensors 1010, 1020, 1030) may be shown on display 1050. For example, as shown in FIG. 11, the user interface may display measurements for a plurality of vital signs recorded with device 1000 including, but not limited to, pulse rate 1110, blood oxygenation level 1112, glucose level 1114, temperature 1116, blood pressure (e.g., systolic and diastolic) 1118, and photoplethysmograph (PPG) 1120. Although six vital signs are shown as being measured with device 1000, it should be appreciated that device 1000 may be configured to measure more or fewer than six vital signs, and embodiments are not limited in this respect.

In some embodiments, signals generated from the sensors in device 1000 are processed using one or more of the techniques described above, to detect noninvasively systolic, diastolic and glucose in addition to pulse, blood oxygenation, PPG, and temperature. In some embodiments, all vital signs are measured and/or calculated within sixty seconds of the user placing their finder in the finger probe 1040.

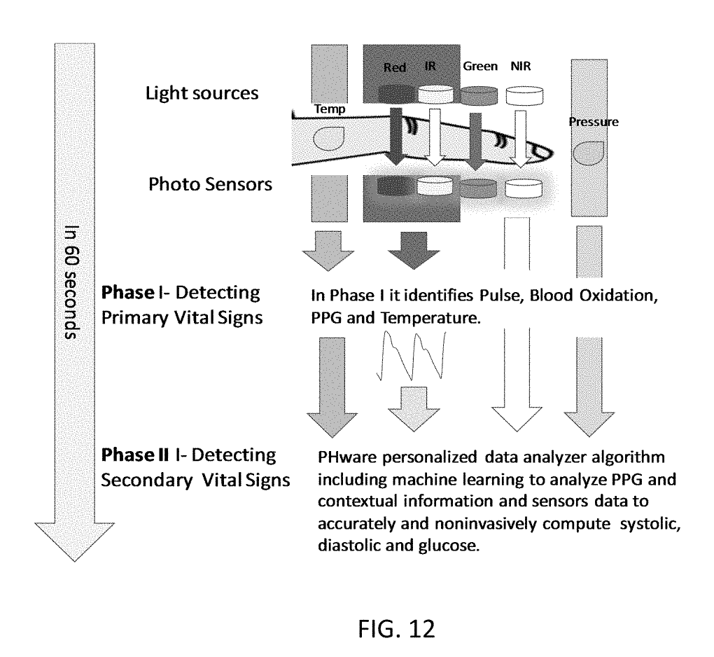

FIG. 12 shows a process for measuring a plurality of vital signs using device 1000 in accordance with some embodiments. As shown, one or more green LEDs are used to determine a skin thickness, and the one or more red, IR and NIR LEDs are used to determine the volume of blood being measured including a detection of pulse rate, PPG and blood oxygenation. In some embodiments, PPG and signals from other sensors in combination with machine learning techniques are used to noninvasively accurately measures blood pressure and glucose without the use of a cuff/pump or finger pricking.

As shown in FIG. 12, in some embodiments, device 1000 is configured to measure vital signs in two phases. In a first phase, sensor data from photosensors 1030, temperature sensors 1020 and a barometric pressure sensor is captured and processed to generate primary vital sign measurements for pulse rate, blood oxidation level, PPG, and temperature.

At least some of the data generated in phase one is provided as input to phase two to generate secondary vital sign measurements using one or more of the data analytic techniques described above. For example, PPG, contextual information and sensor data from green and NIR photosensors, temperature sensors, and barometric pressure sensors may be used to noninvasively compute systolic and diastolic blood pressure and a glucose level, the results of which are displayed to the user, as described above.

In some embodiments, device 1000 includes a biometric sensing capability that uses an individual's unique fingerprint identification to enable the device to be shared among groups of people, such as family members of a household or patients of a clinic, and to provide personalized analysis of the vital signs in response to detecting which individual is using the device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, a tape, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A system for providing a health awareness of a medical condition to an individual, the system comprising:
a healthcare data interface configured to receive clinical data describing healthcare characteristics of the individual;
at least one sensor configured to capture over time patient generated data related to the medical condition; and
at least one computer processor programmed to:
determine a health status of the medical condition based, at least in part, on the received clinical data, the captured patient generated data, and contextual information for the individual; and
output an indication of the health status to provide the health awareness of the medical condition to the individual.

2. The system of claim 1, wherein the clinical data comprises data from an electronic health record for the individual.

3. The system of claim 2, wherein the clinical data comprises data from one or more of a medical history, a patient encounter, a laboratory report, a clinical diagnosis, and a clinical treatment.

4. The system of claim 1, wherein the at least one sensor comprises one or more of a wearable patch configured to capture the patient generated data, a glucose monitor configured to capture a plurality of glucose levels.

5. The system of claim 1, wherein the at least one sensor is further configured to capture at least some of the contextual information.

6. The system of claim 1, wherein determining a health status based, at least in part, on the patient generated data comprises performing a time-series analysis on the patient generated data, and determining the health status based, at least in part, on the time-series analysis.

7. The system of claim 1, wherein the at least one computer processor is further programmed to:
generate at a first time, a personalized baseline measure for at least one biomarker included in the patient generated data; and
store the personalized baseline measure in a storage device accessible by the at least one computer processor.

8. The system of claim 7, wherein determining a health status comprises determining the health status based, at least in part, on the personalized baseline measure by detecting, at a second time, a deviation in the patient generated data from the personalized baseline measure for the at least one biomarker.

9. The system of claim 1, wherein the at least one computer processor is further programmed to generate a personalized health status model for the individual and update the personalized health status model based at, least in part, on one or more of the clinical data, the patient generated data, and the contextual information, and
wherein determining a health status comprises determining the health status based on at least one output of the updated personalized health status model.

10. The system of claim 9, wherein generating a personalized heath status model comprises selecting, based on the medical condition, an individual-independent health status model from a plurality of individual-independent health status models and personalizing the individual-independent health status model to generate the personalized health status model based, at least in part, on one or more of the clinical data, the patient generated data, and the contextual information.

11. The system of claim 10, wherein the at least one computer processor is further programmed to generate a first multi-dimensional model of the plurality of individual-independent health status models by:
analyzing population data for the medical condition to identify patterns in the population data; and
using a machine learning technique to train the first multi-dimensional model on the identified patterns.

12. The system of claim 10, wherein the at least one processor is further programmed to generate a first multi-dimensional model of the plurality of individual-independent health status models based, at least in part, on a semantic graph.

13. The system of claim 9, wherein updating the personalized health status model comprises using a machine learning technique to train the personalized health status model based at, least in part, on one or more of the clinical data, the patient generated data, and the contextual information.

14. The system of claim 13, wherein the at least one computer processor is further programmed to select the machine learning technique from a plurality of machine learning techniques based, at least in part, on the contextual information.

15. The system of claim 1, further comprising an interface configured to receive personalized biometric data for the individual, and wherein the at least one computer processor is further programmed to determine the health status based, at least in part, on the received personalized biometric data.

16. The system of claim 15, wherein the personalized biometric data includes genetic profile information for the individual.

17. The system of claim 1, wherein the at least one computer processor is further programmed to generate a contextual health information model based, at least in part, on the clinical data, the patient generated data, and the contextual information, and wherein determining a health status of the medical condition comprises determining the health status using the contextual health information model.

18. The system of claim 17, wherein generating the contextual health information model comprises weakening or strengthening associations between nodes in the contextual health information model corresponding to the clinical data and/or the patient generated data based on the contextual information.

19. The system of claim 1, wherein the at least one sensor is included in a device configured to non-invasively periodically capture health information from the patient, wherein the health information includes blood pressure, a blood oxygenation level, a pulse rate, temperature, glucose level data, and a photoplethysmograph (PPG),
wherein the at least one computer processor is further programmed to determine the health status of the medical condition based, at least in part, on at least some of the captured health information.

20. A system for dynamically providing a health awareness to a diabetic patient, the system comprising:
a healthcare data interface configured to receive clinical data from an electronic health record of the patient;
a device configured to non-invasively periodically capture health information from the patient, wherein the health information includes blood pressure, a blood oxygenation level, a pulse rate, temperature, glucose level data, and a photoplethysmograph (PPG); and
at least one computer processor programmed to:
determine a health status of the diabetic patient based, at least in part, on the received clinical data, at least some of the captured health information, and contextual information for the patient; and
output an indication of the health status to provide the health awareness to the diabetic patient.

21. The system of claim 20, wherein the at least one computer processor is further programmed to determine the health status of the diabetic patient based, at least in part, on a longitudinal measurement of one or more biomarkers, at least one of which is a blood-based biomarker selected from the group consisting of HbA1c, CRP, LDL, HDL, an LDL/HDL ratio, and triglycerides.

22. A system for providing health awareness to a patient, the system comprising:
a healthcare data interface configured to receive clinical data for the patient;
a device configured to non-invasively periodically capture health information from the patient, wherein the health information includes blood pressure, a blood oxygenation level, a pulse rate, temperature, glucose level data, and a photoplethysmograph (PPG);
a wearable sensor configured to periodically capture patient generated data, wherein the patient generated data includes one or more of diet information, activity information, step number information, and heart rate information; and
at least one computer processor programmed to:
determine whether the patient is a pre-diabetic patient based, at least in part, on the received clinical data, at least some of the captured health information, the captured patient generated data, and contextual information for the patient;
predict, when it is determined that the patient is pre-diabetic, an outcome for the patient, wherein the prediction is based, at least in part, on the received clinical data, at least some of the captured health information, the captured patient generated data, and the contextual information for the patient; and
output an indication of the prediction of the outcome to provide the health awareness to the patient.
